(19) United States
(12) Patent Application Publication
(10) Pub. No.: US 2005/0084147 A1
(43) Pub. Date: Apr. 21, 2005

(54) Method and apparatus for image reconstruction with projection images acquired in a non-circular arc

(76) Inventor: Daniel Eduardo Groszmann, Cambridge, MA (US)

Correspondence Address: MCANDREWS HELD & MALLOY, LTD, 500 WEST MADISON STREET, SUITE 3400, CHICAGO, IL, 60661, US

(21) Appl. No.: 10/689,339

(22) Filed: Oct. 20, 2003

(51) Int. Cl. G06K 9/00

(52) U.S. Cl. 382/131

(57) ABSTRACT

Certain embodiments relate to a system and method for forming a virtual isocenter in an imaging system. The method includes determining a distance between a detector and an object to be imaged, determining a distance between a detector and source, varying either or both distances between image exposures, and adjusting image data obtained from the image exposures for a change in magnification between image exposures. The distance may be determined using a tracking system. The method may also include reconstructing at least one image of the object from the image data adjusted for the change in magnification. Additionally, a position of the object may be maintained at a virtual isocenter formed by varying the distance between the detector and the object and/or the source and the object. The method may further include moving a support including the detector and a source in a non-circular path to move the detector and the source around the object while varying the distance between the detector and the object.

### RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### BACKGROUND OF THE INVENTION

The present invention generally relates to image reconstruction. In particular, the present invention relates to image reconstruction for images obtained along a non-isocentric path.

Medical diagnostic imaging systems encompass a variety of imaging modalities, such as x-ray systems, computerized tomography (CT) systems, ultrasound systems, electron beam tomography (EBT) systems, magnetic resonance (MR) systems, and the like. Medical diagnostic imaging systems generate images of an object, such as a patient, for example, through exposure to an energy source, such as x-rays passing through a patient, for example. The generated images may be used for many purposes. For instance, internal defects in an object may be detected. Additionally, changes in internal structure or alignment may be determined. Fluid flow within an object may also be represented. Furthermore, the image may show the presence or absence of objects in an object. The information gained from medical diagnostic imaging has applications in many fields, including medicine and manufacturing.

Three-dimensional (3D) imaging has become increasingly useful in medical diagnostic procedures and surgical planning. In a CT system, for example, a fan-shaped x-ray beam is directed at a detector array. To obtain images of a volume of anatomy, an x-ray tube and detector array are rotated around a patient while the patient is advanced along an axis of rotation. Additionally, area-beam or cone-beam detectors, such as image intensifiers, may be used to acquire 3D image data. For example, area-beam 3D imaging of blood vessels in a brain may be obtained using contrast agents.

Area-beam detector 3D imaging systems have operated by rotating an x-ray tube and a detector in circular paths around a central axis of rotation. The axis of rotation is positioned to be at the center of a region or volume of interest of a patient anatomy. An x-ray source and an x-ray detector, such as an image intensifier, are typically mounted on opposite ends of a rotating C-arm support assembly. The x-ray source irradiates a patient with x-rays that impinge upon a region of interest (ROI) and are attenuated by internal anatomy. The x-rays travel through the patient and are attenuated by the internal anatomy of the patient. The attenuated x-rays then impact the x-ray detector. 3D image data is acquired by taking a series of images as the x-ray tube/C-arm/detector assembly is rotated about the axis of rotation on which the region of interest within the patient is centered. A plurality of two-dimensional (2D) cross-section images are processed and combined to create a 3D image of an object being scanned.

Conventional mobile C-arm assemblies utilize simple support structures and geometries to mount the x-ray source and x-ray detector on the C-arm. The support structure holds the x-ray source and detector on the C-arm and maintains a predetermined, constant distance between the x-ray source and x-ray detector. Thus, the distance between the x-ray source and the axis of rotation and the distance between the detector and the axis of rotation remain constant and fixed.

In current C-arm x-ray fluoroscopy imaging systems, a 3D tomographic image reconstruction may be performed by sweeping the C-arm in a semi-circular arc around an object of interest. Using cross-arm motion, the arc is circular and therefore isocentric. For example, using a C-arm, an x-ray beam may be swept around a head of a patient (e.g., a CT scan in a circular arc around the head). The volume image reconstruction is performed through 2D projection scan images. Sweeps are accomplished on cross-arm motion with the C-arm positioned at the head of a table sweeping around the head of the table. Thus, the object stays at the center (isocentric motion).

Many medical procedures and other applications use a view from a side of the patient or other object being imaged. An anatomy or object of interest may not be accessed from the head of the table. However, some C-arm systems are unable to perform a 3D tomographic reconstruction with an orbital motion of the C-arm because the paths of the x-ray source and detector are not isocentric. The object does not remain at the isocenter of the system. Resulting projection images are distorted due to the non-isocentric imaging arc and are unusable for clinical, diagnostic, or navigational purposes. Thus, a system and method facilitating 3D image reconstruction using a non-isocentric imaging arc would be highly desirable. A system and method compensation for distortion and irregularity of the projection images due to non-isocentric motion would be highly desirable.

Thus, there is a need for a system and method that facilitate tomographic image reconstruction using non-circular motion.

### BRIEF SUMMARY OF THE INVENTION

Certain embodiments of the present invention provide a method and system for image reconstruction for images acquired in a non-isocentric path. In a certain embodiment, the method includes varying a distance between a detector and an object to form a virtual isocenter. The method further includes maintaining an object at the virtual isocenter during imaging of the object and normalizing a magnification change in image data obtained as the virtual isocenter is maintained. The method also includes reconstructing an image of the object based on the image data and the normalized magnification change.

The method may also include tracking a position of the detector and a position of the object. The method may vary the detector-to-object distance between image exposures. The method may also determine a distance between the detector and a source. Additionally, a position of the detector and/or a source may be determined with respect to the object. The detector and source may be mounted on a C-arm or other support. The C-arm may be moved in a non-circular arc to move the detector and the source around the object while varying the distance between the detector and the object. A three-dimensional image of the object may be reconstructed based on the image data and the normalized magnification change.

Certain embodiments provide a method for forming a virtual isocenter in an imaging system. The method includes determining a distance between a detector and an object to be imaged, varying the distance between image exposures, and adjusting image data obtained from the image exposures for a change in magnification between image exposures. The distance may be determined using a tracking system, such as an electromagnetic, optical, or mechanical tracking system. The tracking system may determine a position of the detector and/or a source with respect to the object. The method may also include reconstructing at least one image of the object from the image data adjusted for the change in magnification. Additionally, a position of the object may be maintained at a virtual isocenter formed by varying the distance between the detector and the object. The method may further include moving a support including the detector and a source in a non-circular arc to move the detector and the source around the object while varying the distance between the detector and the object.

Certain embodiments of a system for processing images obtained using non-isocentric motion include a source for providing an emission used to generate an image of an object, a detector for receiving the emission after the emission has traveled through the object to produce image data, and a support for positioning the source and the detector, the support varying at least one of a distance between the detector and the object and a distance between the source and the object when obtaining the image data from the emission. The system also includes a tracking system for obtaining position data relating to at least one of the source, the detector, and the object and an image processor for reconstructing at least one image using the image data and the position data, the image processor compensating for a change in magnification between image data when reconstructing at least one image.

In an embodiment, the change in magnification is due to varying at least one of a distance between the detector and the object and a distance between the source and the object. In an embodiment, the tracking system comprises an electromagnetic tracking system. An electromagnetic sensor may be located on the detector, and an electromagnetic transmitter may be located on the object, for example. The support in the system may be a C-arm, L-arm, or other support. The system may also include a positioning device for positioning the object with respect to the support.

### BRIEF DESCRIPTION OF SEVERAL VIEWS OF THE DRAWINGS

FIG. 1 illustrates an imaging system used in accordance with an embodiment of the present invention.

FIG. 2 shows a change in detector-to-object distance at different positions along a sweep of a C-arm used in accordance with an embodiment of the present invention.

FIG. 3 depicts a change in detector-to-object distance during a non-circular orbital motion of a C-arm in accordance with an embodiment of the present invention.

FIG. 4 illustrates a flow diagram for a method for establishing a virtual isocenter in an imaging system used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

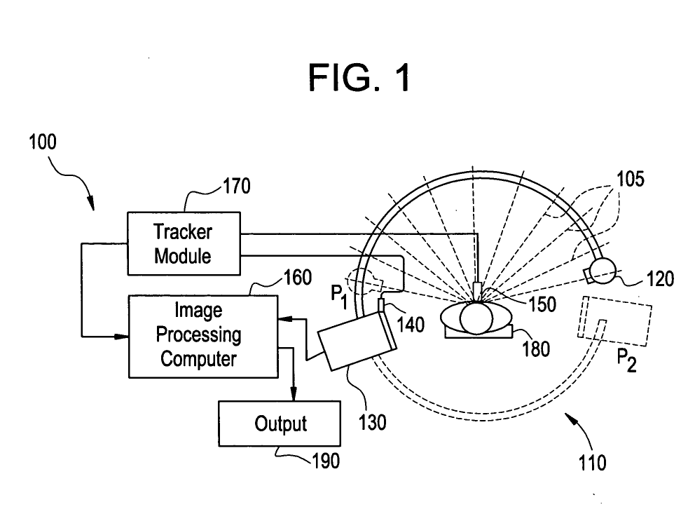

FIG. 1 illustrates an imaging system 100 used in accordance with an embodiment of the present invention. The system 100 may be a variety of systems including an x-ray system, a CT system, an EBT system, an ultrasound system, an MR system, or other imaging system. In an embodiment, the system 100 includes a C-arm 110, an x-ray source 120, an x-ray detector 130, an electromagnetic (EM) sensor 140, an EM transmitter 150, an image processor 160, a tracker module 170, a positioner 180, and an output 190. The x-ray source 120 and the x-ray detector 130 are mounted on opposing sides of the C-arm 110. The x-ray source 120 and x-ray detector 130 may be movably mounted on the C-arm 110. In an embodiment, the EM sensor 140 is mounted on the x-ray detector 130. The EM transmitter 150 is positioned on an object, such as a patient, to be imaged. Alternatively, the EM transmitter 150 may be located on the x-ray detector 130, and the EM sensor 140 may be located on the object being imaged. The object is positioned on or in the positioner 180, such as a table, a table bucky, a vertical bucky, a support, or other positioning device, for imaging.

The C-arm 110 is movable in several directions along multiple image acquisition paths, including an orbital direction, longitudinal direction, lateral direction, transverse direction, pivotal direction, and “wig-wag” direction, for example. In an embodiment, the x-ray source 120 and detector 130 may be moved on the C-arm 110. Thus, the C-arm 110 with x-ray source 120 and x-ray detector 130 may be moved and positioned about the positioner 180 on or in which the object to be imaged has been situated. The C-arm 110 is used to position the x-ray source 120 and detector 130 about the object so that x-rays 105 or other such energy may irradiate the object for use in producing an image. The C-arm 110 may be moved or re-positioned at a variety of scan angles around the object to obtain a plurality of images. As the C-arm 110 moves, the distance between the x-ray detector 130 and the object may vary. The distance between the x-ray source 120 and the object may also vary.

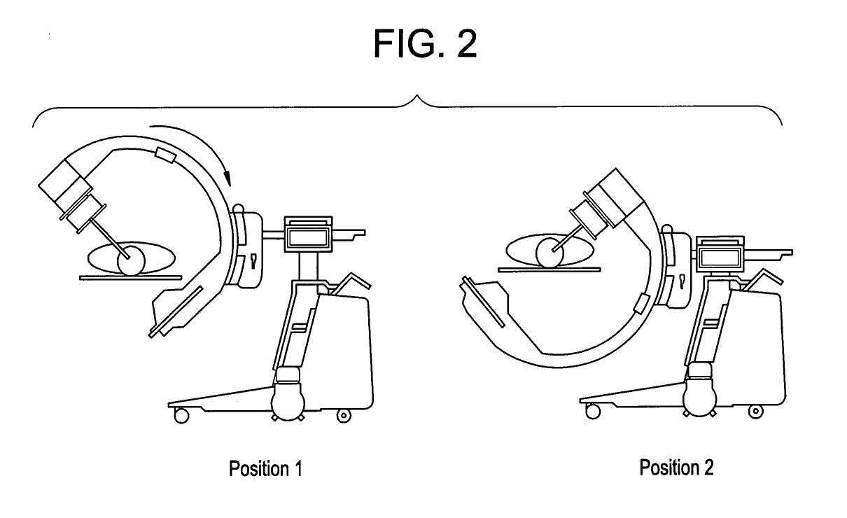

The x-ray source 120 and the detector 130 on the C-arm 110, such the OEC 9800 C-arm, may move in a cross-arm or orbital motion, for example. In an orbital motion, the x-ray source 120 and the detector 130 do not move in a circular path. In tomographic image reconstruction using orbital motion, a distance between the detector 130 and the object (and a distance between the source 120 and the object) may vary during collection of projection images. FIG. 2 shows a change in detector-to-object distance at different positions along a sweep of the C-arm 110 used in accordance with an embodiment of the present invention. As shown in FIG. 2, a sweep begins at Position 1 and ends at Position 2. In order to keep the patient in a center of a field of view, a position of the C-arm 110 is adjusted because the C-arm 110 motion is not isocentric. Non-isocentric motion of the C-arm 110 changes the object-to-detector distance between Position 1 and Position 2 and results in magnification changes in a resulting image. By changing the detector-to-object distance, a virtual isocenter may be formed for the object for use in image processing and reconstruction.

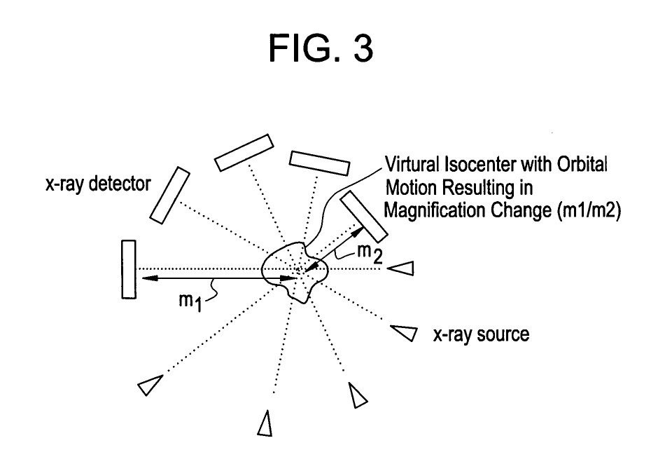

Varying the detector-to-object distance (and the source-to-object distance) maintains the object of interest in the field of view of the x-ray detector 130. FIG. 3 depicts a change in detector-to-object distance during orbital motion of the C-arm 110 in accordance with an embodiment of the present invention. As shown in FIG. 3, the detector-to-object distance (and/or the source-to-object distance) changes along the non-circular path of the detector 130 and source 120 around the object. Thus, magnification in a resulting image changes from m₁ at a first position to m₂ at a second position for a magnification change of m₁/m₂.

In an embodiment, a position of the x-ray detector 130 may be recorded for each projection image. Additionally, a distance between the detector 130 and the x-ray source 120 may be determined. A magnification change may be quantified and compensated for during tomographic image reconstruction using the detector 130 position and detector-to-object distance. The EM sensor 140 or other tracking device may be placed on the detector 130. The EM transmitter 150 or other tracking device may be placed on the object. Data from the sensor 140 and transmitter 150 may be used to determine a position of the detector 130 during a trajectory of the detector 130. Other tracking devices, such as optical or mechanical tracking devices, may be used to determine a position of components in the system 100.

The transmitter 150 broadcasts a signal, such as a magnetic field, that is detected by the sensor 140. The tracker module 170 uses data from the transmitter 150 to determine a position of the detector 130 with respect to the object. Differences in position and, thus, distance between the detector 130 and the object correspond to differences in magnification in obtained x-ray projection images.

Changing distance between the detector 130 and the object and/or distance between the source 120 and the object changes the magnification of the object projected onto the detector for point sources or near-point sources that emit non-parallel beams, such as x-rays. If the field of view of the x-ray source 120 is constant, as an object approaches the x-ray source 120, the object occupies more of the field of view and therefore projects as a larger image onto the detector 130. In an embodiment, the detector-to-object distance is varied to maintain the object at a virtual isocenter of the system 100. In an embodiment, the C-arm 110 and/or the source 120 and/or detector 130 on the C-arm 110 may be moved in any plane or not moved to position the object at the virtual isocenter in the field of view of the detector 130. Measurement of the varying detector-to-object and/or source-to-object distance allows the image processor 160 to compensate for the change in distance and thus the change in magnification. The tracker module 170 may use data from the EM sensor 140 and EM transmitter 150 or other tracking device to track the detector-to-object distance.

Alternatively, the EM sensor 140 or EM transmitter 150 may be mounted on the source 120 with the EM transmitter 150 or EM sensor 140 on the object to determine position of the source 120. A position of the x-ray source 120 may be recorded and used with the source-to-detector distance to determine and account for the magnification change. The tracker module 170 may also monitor a position of an instrument or tool used during a diagnostic or surgical procedure, for example.

The tracker module 170 monitors a position of the object, the x-ray detector 130, and/or the x-ray source 120 in the system 100. The tracker module 170 may provide position data in a reference coordinate system with respect to the object, source 120, and/or detector 130. The image processor 160 uses the position data when processing the image data to reconstruct 2D and/or 3D images. The position data may also be used for other purposes, such as surgical navigation, for example. In an embodiment, the tracker module 170 continuously calculates the positions of the x-ray detector 130 and object with respect to a coordinate system defined relative to a coordinate system reference point or central axis. In an embodiment, the image processor 160 may generate control or trigger commands to the x-ray source 120 or source controller to scan the object based on position data.

The image processor 160 collects a series of image exposures from the detector 130 as the C-arm 110 is moved. The detector 130 receives an image exposure each time the x-ray source 120 is triggered. The image processor 160 combines image exposures with reference data to reconstruct a 3D volumetric data set. The 3D volumetric data set may be used to generate images, such as slices, or a region of interest from the object. For example, the image processor 160 may produce from the volumetric data sets sagittal, coronal, and/or axial views of a patient spine, knee, or other area. The image processor 160 may be implemented in software and/or hardware. The image processor 160 may be a general purpose computer, a microprocessor, a microcontroller, and/or an application-specific integrated circuit, for example.

A tomographic image reconstruction algorithm, such as a filtered back-projection scheme, backprojection, algebraic reconstruction, forward projection, Fourier analysis, or other reconstruction method, may be used to process the images obtained from a non-circular path of the C-arm 110. For example, a filtered back-projection algorithm may be used to reconstruction image(s) of the object using a relationship between a volume of interest and each projection image. The magnification change is quantified for the relationship between the volume of interest and the projection image(s). The magnification change data is used to adjust or normalize the image data to reconstruct the desired image(s) of the object.

A 3D image reconstruction may be formed by combining successive slices or planes scanned of an object using a fan beam. A 3D image reconstruction may also be formed by rotating the source 120 and detector 130 around the object to obtain cone or area beam projections of the object. In a cone beam projection, the object may be illuminated with a point source and x-ray flux measured on a plane by the detector 130. The distance from the object to the detector 130 and the distance from the object to the source 120 may be used to determine parallel projections for image reconstruction. Filtered backprojection may also be used to reconstruct a 3D image based on filtering and backprojecting a plane in a cone beam. In a filtered backprojection, individual fan beam or cone beam projections are analyzed and combined to form a 3D reconstruction image. Fan beams are tilted out of a source-detector plane of rotation for analysis in a new coordinate system for filtered backprojection. Projection data is weighted based on distance and convolved. Then, the convolved weighted projections are backprojected over a 3D reconstruction grid to reconstruct a 3D image.

After the image(s) have been reconstructed, the image processor 160 may transmit the image(s) to the output 190. The output 190 may be a display, a printer, a facsimile, an electronic mail, a storage unit, or other medium, for example. The image(s) may be displayed and/or stored via the output 190 for use by a user such as a technician, physician, surgeon, other healthcare practitioner, or security officer.

In operation, for example, a patient's mid-spinal area may be scanned in the system 100. The C-arm 110 may not reach all positions of a mid-spinal scan when the patient is positioned on a table, such as the positioner 180. Therefore, the C-arm 110 may be moved and positioned from a side. As the C-arm 110 is moved in a non-circular motion, the spine may not remain centered in scanned images because the path of the C-arm 110 is not circular, as shown in FIGS. 2 and 3. The C-arm 110 is moved, such as raising and lowering the C-arm 110 on a C-arm support, to keep the spine in the center (e.g., a virtual isocenter). As the C-arm 110 is moved and the spine is not moved, the spine is located closer or farther from the x-ray source 120. Thus, obtained images have a different magnification from start to finish (for example, five vertebral levels in a first image to three vertebral levels in a last image due to more magnification) because the C-arm 110 moves in a non-circular arc. A change in magnification may be determined because position of the detector 130 with respect to the object being scanned is measured by the tracker module 170 using the EM transmitter 150 and sensor 140, for example. Then, the magnification change is taken into account during reconstruction of a 3D volume image of the mid-spinal area. Rather than using a fixed distance in standard image reconstruction algorithms, the variable distance values are used in reconstruction calculations for the image(s).

Thus, certain embodiments capture distance measurements dynamically rather than a fixed distance value. Additionally, certain embodiments accommodate a change in magnification when reconstructing image(s) of an object. Certain embodiments maintain a virtual isocenter at which an object is positioned during a non-isocentric imaging sweep. Certain embodiments may be used with image data obtained from a variety of systems and signals, such as x-rays, ultrasound, infrared, or other wavelengths from visible to invisible wavelengths.

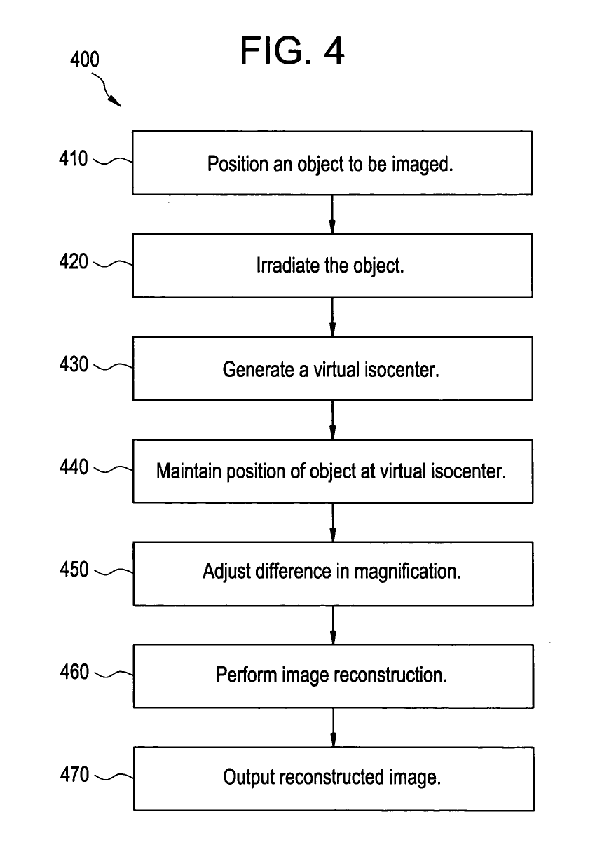

FIG. 4 illustrates a flow diagram for a method 400 for establishing a virtual isocenter in an imaging system used in accordance with an embodiment of the present invention. First, at step 410, an object to be imaged, such as a patient, is positioned in the path of an emission source, such as the x-ray source 120. The emission source may be mounted on a support, such as an L-arm or C-arm 110, with an emission detector. Then, at step 420, an emission, such as a beam of x-rays, passes through or irradiates the object.

Next, at step 430, a virtual isocenter is generated in the imaging system based on a distance between the object and the emission source or detector. A tracking system, such as an EM, optical, or mechanical tracking system, may be used to determine distances in the imaging system, for example. For example, the EM sensor 140 may be mounted on the x-ray detector 130 and the EM transmitter 150 may be mounted on the object to determine a detector-to-object distance during imaging. At step 440, the emission source and/or emission detector is moved as the object is scanned such that the object remains at the virtual isocenter. A position and orientation of the source may be adjusted as the source and support are moved. If the C-arm 110 is moved in a non-circular, for example, the x-ray detector 130 may be moved to help ensure the object remains at the virtual isocenter defined in the system 100.

Then, at step 450, a difference in magnification due to a difference in distance between the object and the source or detector is adjusted. That is, a difference in image magnification between subsequent exposures due to a change in detector-to-object or source-to-object distance is corrected or adjusted using the detector-to-object and/or source-to-object distance for the exposure and the detector-to-source distance. Thus, a magnification level is normalized for image exposures based on distances between the object, source, and/or detector.

Next, at step 460, tomographic image reconstruction is performed using image data and distance data. That is, the image data may be modified using the distance data to produce image(s) unaffected by changes in magnification due to repositioning of the source, detector, and/or support. At step 470, the image(s) of the object are output. The image(s) may be output to a display, a printer, a facsimile, an electronic mail, a storage unit, or other medium, for example. In an embodiment, a user, such as a surgeon, may reliably use the resulting image(s) without concern for magnification changes or deviation from an isocenter.

Thus, certain embodiments of the present invention provide a system and method for creating a virtual isocenter when scanning an object. Certain embodiments provide a system and method that maintains an object in the field of view of an x-ray detector during x-ray detector motion. Additionally, certain embodiments compensate for magnification differences between images obtained of an object during motion of a C-arm.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for image reconstruction for images acquired in a non-isocentric path, said method comprising:
varying a distance between an object and at least one of a detector and a source to form a virtual isocenter;
maintaining an object at said virtual isocenter during imaging of said object;
normalizing a magnification change in image data obtained as said virtual isocenter is maintained; and
reconstructing an image of said object based on said image data and said normalized magnification change.

2. The method of claim 1, further comprising tracking a position of said detector and a position of said object.

3. The method of claim 1, wherein said varying step further comprises varying said distance between image exposures.

4. The method of claim 1, further comprising determining a distance between said detector and a source.

5. The method of claim 1, further comprising determining a position of at least one of said detector and a source with respect to said object.

6. The method of claim 1, further comprising mounting said detector and a source on a C-arm.

7. The method of claim 6, further comprising moving said C-arm in a non-circular path to move said detector and said source around said object while varying said distance between said detector and said object.

8. The method of claim 1, wherein said reconstructing step further comprises reconstructing a three-dimensional image of said object based on said image data and said normalized magnification change.

9. A method for forming a virtual isocenter in an imaging system, said method comprising:
determining a distance between an object to be imaged and at least one of a detector and a source;
varying said distance between image exposures; and
adjusting image data obtained from said image exposures for a change in magnification between image exposures.

10. The method of claim 9, wherein said determining step further comprises determining a distance between said detector and said object using a tracking system.

11. The method of claim 10, wherein said tracking system comprises an electromagnetic tracking system for determining a position of said detector with respect to said object.

12. The method of claim 9, further comprising reconstructing at least one image of said object from said image data adjusted for said change in magnification.

13. The method of claim 9, further comprising maintaining a position of said object at a virtual isocenter formed by varying said distance between said object and at least one of said source and said detector.

14. The method of claim 9, further comprising moving a support including said detector and a source in an orbital motion to move said detector and said source around said object while varying said distance between said detector and said object.

15. A system for processing images obtained using non-isocentric motion, said system comprising:
a source for providing an emission used to generate an image of an object;
a detector for receiving said emission after said emission has traveled through said object to produce image data;
a support for positioning said source and said detector, said support varying at least one of a distance between said detector and said object and a distance between said source and said object when obtaining said image data from said emission;
a tracking system for obtaining position data relating to at least one of said source, said detector, and said object; and
an image processor for reconstructing at least one image using said image data and said position data, said image processor compensating for a change in magnification between image data when reconstructing said at least one image.

16. The system of claim 15, wherein said change in magnification is due to varying at least one of a distance between said detector and said object and a distance between said source and said object.

17. The system of claim 15, wherein said tracking system comprises an electromagnetic tracking system.

18. The system of claim 17, wherein said tracking system comprises an electromagnetic sensor located on said detector and an electromagnetic transmitter located on said object.

19. The system of claim 15, wherein said support comprises a C-arm.

20. The system of claim 15, further comprising a positioning device for positioning said object with respect to said support.
